(19) United States
(12) Patent Application Publication
(10) Pub. No.: US 2010/0042501 A1
(43) Pub. Date: Feb. 18, 2010

(54) Method and apparatus for controlling content within a network

(76) Inventor: Hsiu-Ling Lee, Arcadia, CA (US)

Correspondence Address: WANG, HARTMANN & GIBBS, 1301 DOVE STREET, SUITE 1050, NEWPORT BEACH, CA, 92660, US

(21) Appl. No.: 12/228,372

(22) Filed: Aug. 12, 2008

(51) Int. Cl. G06Q 30/00

(52) U.S. Cl. 705/14.53

(57) ABSTRACT

A method an apparatus for controlling the content within a network utilizes user specific information which is part of a communications transmission by a user. The information is monitored and the user specific information such as zip code, news topic, favorite link, etc. is identified. The information is analyzed to determine the most likely relevant advertisements for the user. Selected advertisements that are deemed likely relevant to the user are chosen and the user is notified of the advertisements.

### FIELD OF THE INVENTION

This invention is generally related to networks and to controlling the content within a network at least partially based upon information received from a user.

### BACKGROUND OF THE INVENTION

Most Web sites and apps use Internet Cookies to gather and trace the information about the site's visitors. Cookies are site specific. Cross-site profiling is not a capability because Cookies are not programs and they cannot run like programs do. Internet Cookies cannot collect any personal information about a person from their machine or PC. Nor can they provide any useful or accurate data to the site's visitors. Reliance on information provided by cookies to determine advertisements to suggest to a user can produce numerous irrelevant and annoying ads from commercial business providers will be delivered and popped up on PCs/machines while site's visitors are surfing the Internet.

The internet is becoming a part of people's daily life and also getting into family's living room today, so it's a LIFE-STYLE change in today's life. It affects ourselves and our children's life dramatically, such as the applications used today: on-line communication, on-Line Gaming, on-line shopping, on-line watching their favorite u-TUBE movie clips, on-line paying the bills, on-line Banking, on-line study, to name a few.

As part of the internet phenomena, advertising has experienced a rapid and explosive growth. However, advertising on the internet for the most part is not directed to a user's purchasing or interest preference. Rather, the advertisements are either random or based upon information that is either not client specific or imprecise as to client preferences.

What is needed is a more precise manner in which to collect information so that advertisements are more precisely tailored to each user.

### SUMMARY OF THE INVENTION

A method for tailoring advertisement content to a specific user within a network is disclosed in general. In one embodiment, software resides on a user's premises equipment to inspect information sent from said equipment over the network. The software identifies user preference information that is part of the communication from a user sent over the network. In one embodiment, the identified user preference information is sent over the network to a location that collects and analyzes the information. The result of the analysis identifies potential advertisements that might be of interest to the user. The selected advertisements are identified to the user.

### BRIEF DESCRIPTION OF THE DRAWINGS

The invention is generally shown by way of reference to the accompanying drawings in which:

FIG. 1 is a flow illustrating a method in accordance with an embodiment of the invention;

FIG. 2 is a hardware and software functional diagram on CPE while a software running on this method;

FIG. 3 is the flowchart for running one embodiment of the software method;

FIG. 3a is a sample GUI;

FIG. 4 is a flowchart of the general aspects of the invention;

FIG. 5 is a flowchart of one embodiment of the invention; and

FIG. 6 is another flowchart of an embodiment of the invention.

### DETAILED DESCRIPTION OF THE INVENTION

The scope of the present invention can be best understood by reference to the figures, specification, and claims all of which are not intended to be limiting. While an embodiment of the present invention is described in term of the internet, or web, it is important to note that the present invention is not limited to the internet. The teachings support other embodiments that can be applied to a case, for example, where user specific information is transmitted on networks other than the internet. Further, the principles disclosed could be applied to local networks, cell phone networks, or the like. It will be apparent to a person of skill in the art that the teachings herein are transferable to other communication and/or data type infrastructures.

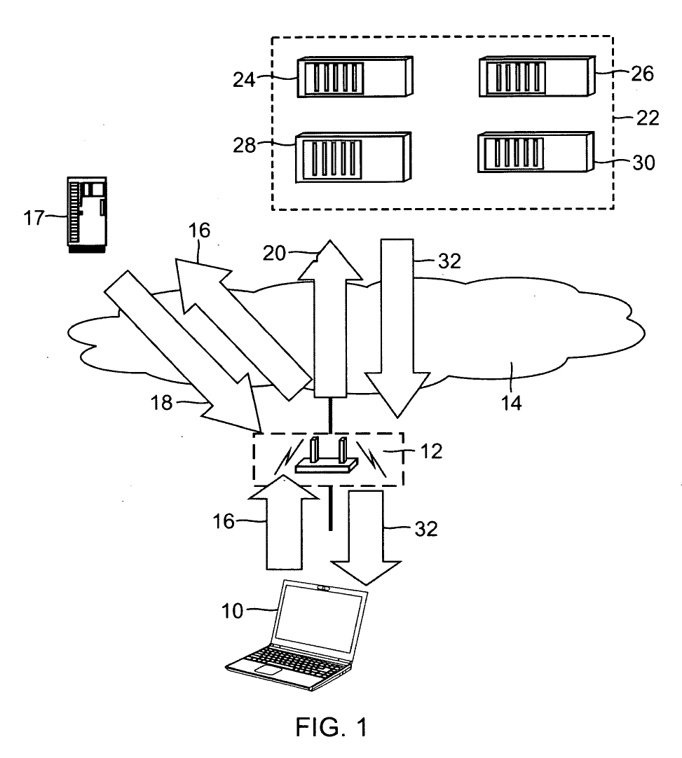

Turning to FIG. 1, a computer 10 is communicatively connected to a router 12, which is in turn connected to the internet 14 or often referred to as the Web. In other embodiments, the computer 10 can be connected to a network without limitation to being connected to a router. If a user types the URL of a Web site into a browser residing on the computer 10, the browser sends a request to the Web site for a page. For example, typing the URL http://www.google.com into a browser results in the browser contacting Google's server and request its home page. “User” or “Client” is used in the broadest sense and includes those who are using the network to purchase, or not purchase, anything. For example, a user or client can be a person who is surfing the internet and has no intent, or even history, as to purchasing. Even so, the preference information can be gathered, analyzed and used to provide likely relevant advertisements to the person. In another example, the user may be using a cell phone over a network.

Still referring to FIG. 1, an HTTP request 16 is sent from the computer 10 to the router 12 and forwarded to the internet 14. The request 16 is then directed to the desired external website 17. The website 17 provides an HTTP response 18 to the internet 14. The response 18 is forwarded to the router 12 and ultimately the computer 10.

One embodiment of the invention utilizes software running on a particular CPE (Client, or User, Premises Equipment or Gadgets such as, but not limited to, a computer, residential gateways, routers, IADs, set top box, mobile units, PC, notebook, and any kind of networking devices) such as the router 12. In other embodiments, the software can be resident on other stationary or mobile network devices and devices having an operating system. The software monitors the request 16 and collects preference information of the user from the HTTP request 16. Preference information can include, for example, products identified in the request. A person of ordinary skill in the art would readily understand the techniques available for monitoring internet communications and communications associated with other networks other than the internet. A person of ordinary skill would also understand how to identify user preference information, for example products. One such process could include comparing information requests to a list of product keywords. When a request includes product, such as a purse, on the list, then the information is tagged as product information.

The user preference information 20 is transmitted is to a URL or backend server 22. The backend server 22 can include, for example, an ad analysis server 24 that analyses the user preference information. Also, there can be a directory server 26, an ad delivery server 28, and a database cluster 30.

In one embodiment, the advertisements could be ranked based upon a fee paid for advertising. In such a case the higher ranked ads chosen would likely be the paid advertisers. Ads can also be chosen based upon cost of products sold. Using purses as an example, chosen ads could be based upon the lowest costing purses. In yet another instance, ads could be chosen based upon location such as zip code or on the maker of the product sought. These highlight the numerous ways in which the ads can be selected for display to a user. In another example, ads could be chosen based on the how frequent numbers of ads have been clicked by users.

In yet another embodiment, the identification of information such as a “purse” would trigger the backend server to pull all information on purses. A narrowing search would then be performed. For example, if the user was interested in a particular color or manufacturer, then the program would choose only the purse data complying with the color or manufacturer.

Rather than just utilizing cookies to identify user related information, one of many aspects of the present invention is to send the information collected from a CPE to a location such as a backend server to record it and to go one step further and provide more useful and relevant information back to site's visitors after running the comparison with, for example, the database cluster 30 from the backend server 22.

Inspecting the information sent from a user's premises equipment over the network is not merely utilizing cookies. In one embodiment, the inspection is done by monitoring the communication traffic sent from the user in, for example, HTML based information directed over the internet to a Website.

Identifying user preference information being included in the information sent over the network involves an interpretation of the inspected information. For example, internet HTML based information sent by a user may contain the identity of products the user is searching for over the internet. The program would identify that product.

Further, in one embodiment a history is kept as to the preference information. In that fashion a user may search for a product, such as a purse for example. The purse related preference information would be collected and the historical information of prior user searches for a purse would be used to assist in identifying targeted advertisements. Specific type of purses sought in the past could be used to target a specific manufacturer, type of purse, cost range for a purse, to name just a few.

Once the user's preference information is analyzed, advertisements are chosen that are likely to be of interest to the user based upon the preference information. This is one of many ways in which advertisement can be tailored to the specific user. In one embodiment targeted ads can be chosen based upon the zip code of the user and the product sought. In this way a user would be given information as to local establishments that carry the product. The targeted ad information 32 is sent to the internet 14 and then forwarded to the router 12 and computer 10.

The computer 10 displays the targeted ad information 32 to the user. The user may have substantial control over such factors as the number of ads displayed, the location of the ads on the computer display, and the ability to notify the backend server 22 that a particular ad is more or less desirable than other ads.

In one embodiment, the software on the CPE will inspect each data packet of out-bound traffic and filter non-HTTP protocol. The MAC address+User Name as unique user's ID can be used.

In this embodiment, the method is an end-to-end and system level design approach. It means there is a set of management API resides in the CPE in order to do the information transmitting between CPE and Server. To automate the configuration, provisioning and management of CPE, a set of API or parameters could be used which could be accessible from Server. The software initiates the necessary HTTPS requests to the CPE on the specific port and the CPE responds with the data encoded in XML streams in the content portion of HTTPS messages. That said, the CPE will provide an HTTPS on a specific port that will accept commands using the HTTP “String” for some/all parameters, with the reply in XML from a defined response stricture or possible binary data. The post/SET method is used to specify the command to execute on the CPE and to provide input parameters. The body of the POST command can contain XML formatted data or binary data. The GET method of HTTP is used to extract the data from the CPE.

Below is an example for the HTTP formatting to control and transmit the data information between CPE and Server. When users type any URL of Web site on the browser, the software resided in the CPE will send a notice to Server. The Server will make a request by sending an HTTP GET command to the following URL: https://deviceweb/ . . . /get_client_info.xml in order to gather all web visitors' information

A sample HTTP/XML response from the CPE is as follows:

```
Get_client_info.xml
    −<client_info>
        <lan_client_details>
            <lan_client_ip_addr>192.168.1.101</lan_client_ip_addr>
            <lan_client_mac_addr>0220-E046-G3D4<lan_client_mac_addr>
            <lan_client_request_url>www.yahoo.com</lan_client_request_url>
            <lan_client_request_url_ip_addr></lan_client_request_url_ip_addr>
            <lan_client_url_keyword>purse</lan_client_url_keyword>
            <lan_client_date> Mon, 21 Apr 2008 12:17:41 PST
            </lan_client_date>
            <lan_client_session_time>3m</lan_client_session_time>
            <lan_client_zip_code>91077</lan_client_zip_code>
        </lan_client_details>
        <lan_client_details>
            <lan_client_ip_addr>192.168.1.102</lan_client_ip_addr>
            <lan_client_mac_addr>0410-E455-A8D6<lan_client_mac_addr>
            <lan_client_request_url>www.cdw.com</lan_client_request_url>
            <lan_client_request_url_ip_addr></lan_client_request_url_ip_addr>
            <lan_client_url_keyword></lan_client_url_keyword>
            <lan_client_date> Fri, 26 Apr 2008 19:45:33 GMT
            </lan_client_date>
            <lan_client_session_time>30s</lan_client_session_time>
            <lan_client_zip_code>91077</lan_client_zip_code>
        </lan_client_details>
        <lan_client_details>
            <lan_client_ip_addr>192.168.1.102</lan_client_ip_addr>
            <lan_client_mac_addr>0410-E455-A8D6<lan_client_mac_addr>
            <lan_client_request_url>www.cdw.com/shop/search/results.a
            spx?key=WRT54G&platform=All&sr=1&Find+it.x=25&Find
            +it.y=17/</lan_client_request_url>
            <lan_client_request_url_ip_addr></lan_client_request_url_ip_addr>
            <lan_client_url_keyword>wrt54g</lan_client_url_keyword>
            <lan_client_date> Fri, 26 Apr 2008 19:46:03 GMT
            </lan_client_date>
            <lan_client_session_time>2m</lan_client_session_time>
            <lan_client_zip_code>91077</lan_client_zip_code>
        </lan_client_details>
        <wan_ip_addr>123.234.345.456</wan_ip_addr>
        <error_no>0</error_no>
        <error_desc>No Error</error_desc>
      </client_info>
```

The information contains product information such as a “purse” and a variety of web locations such as “yahoo.com”. In this example, user preference information could be identified by a program that monitors the communications traffic for “keywords”, “lan_client_request_url”, “wan_ip_addr”, “lan_client_zip_code” and “lan_client_mac_addr.” Continuing with this example, the program could localize prospective advertisements to those in a particular zip code using the “lan_client_zip_code”. Then, within that zip code, the program could identify purses through “keywords” to find purses in the zip code. One way this could be accomplished is through a comparison of “keywords” information to a list of products kept in a backend server. It is important to note that this is just a sampling of what could be considered a limited amount of user preference information.

Information sent to and from the premises equipment could be made secure communications using, for example, applicable encryption algorithms.

A combination of premises equipment can be used to implement an embodiment of the invention. For example, a client's computer could be used in connection with a router to intercept and/or analyze the information. As an alternative, a user's computer memory could be used to retain advertisement information while the router performs the interception and review of the user preference information.

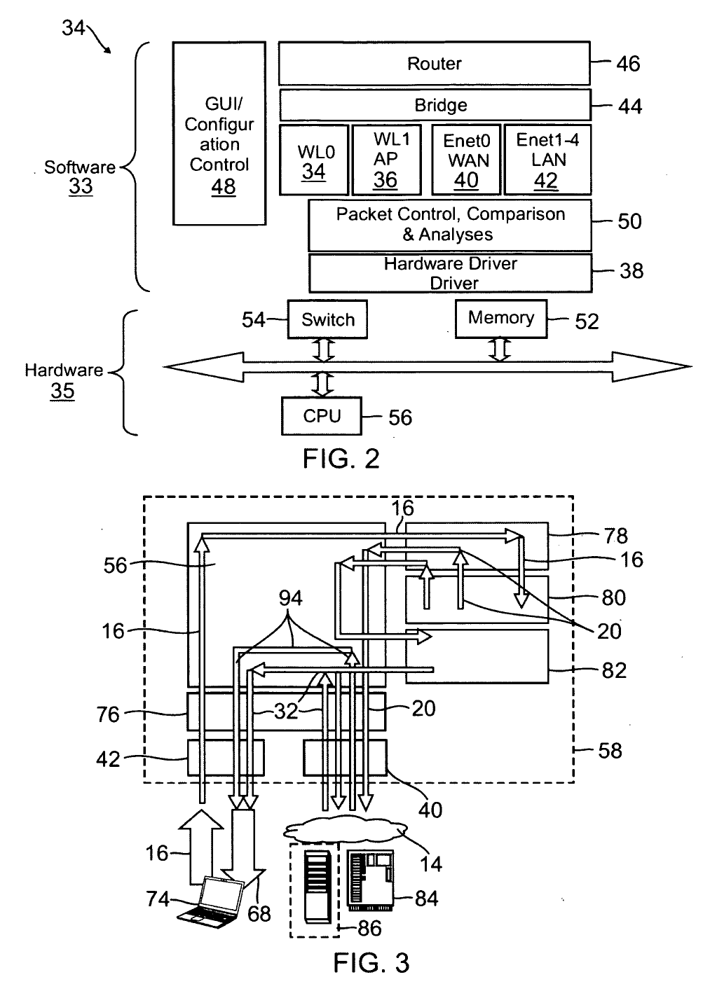

Referring now to FIG. 2, there is identified both software 33 and hardware 35 to support one embodiment of the invention. Starting with the software, the WL0 34 (Wireless Station) is where users connecting to CPE via wireless devices. WL1 36(Wireless Access Point) is an access point on the CPE to gather all wireless packets from wireless station. The hardware driver 38 is specific to a device. Enet0 40 identifies the WAN port. Enet1 42 is the LAN port. Also, in general, many routers or CPEs contain four Ethernet ports usually noted as 1-4 ports.

FIG. 2 also identifies the bridge software 44 where the software runs on Layer 2 protocol and the router software 46 where the software runs on Layer 3 protocol. The GUI 48 (Graphic User Interface) is most usually a Web GUI to configure a particular CPE. It can turn-on and off this method as well as being a control information center to allow user to access it. Web GUI is the place which allow users key in their potential area of interest and display the relevant ads afterward.

There is user specific information 50 running to collect all inbound packets but filtering non-HTML information. By inspecting all outbound HTTP protocol and deliver it to backend server. It's responsible for receiving all packets and doing comparison/analyses & push the advertise program to PCs that associated with the backend or Ad Server.

An embodiment can utilize software that resides both on the CPE and Server. The software has the ability to monitor information sent from the client and received by the client. The software is capable of identifying client information that could be used in tailoring specific advertisements. In such an instance, the software on the CPE works in conjunction with the software on a backend server. This can be done in a number of ways including the CPE software performing a limited number of tasks such as the initial screening of HTML information and comparing that information to a resident listing for a preliminary analysis. The results of the analysis may be sent to the backend server for further analysis.

In another embodiment, software resident on the CPE is designed as the front gate and control center for managing these internet applications that cross-site profiling in an integrated manner as well as including home networking data. It records inbound and outbound HTTP traffics to get more accurate information from site's visitors such as demographics, spending habits, customer location . . . etc.

By inspecting outbound HTML information, this kind of user information could be gathered on CPE (it would be router, gateway, IAD . . . etc). The CPE would latter or coincidently provide this information to a backend server. Per this method, the more useful information to users or/and precise Ad would be obtained after running the program on Server. For example, it would distribute or/and provision the Supermarket's grocery coupons per specific ZIP code. This method provides capabilities that make the Web sites much easier to navigate and gather more accurate information about the site's visitors with a better user experience.

Turning now to the hardware elements of FIG. 2, the monitoring 52 is typically some buffer on memory for Ads data base stored on local device. There is a specific information identified 54 and information is sent 56.

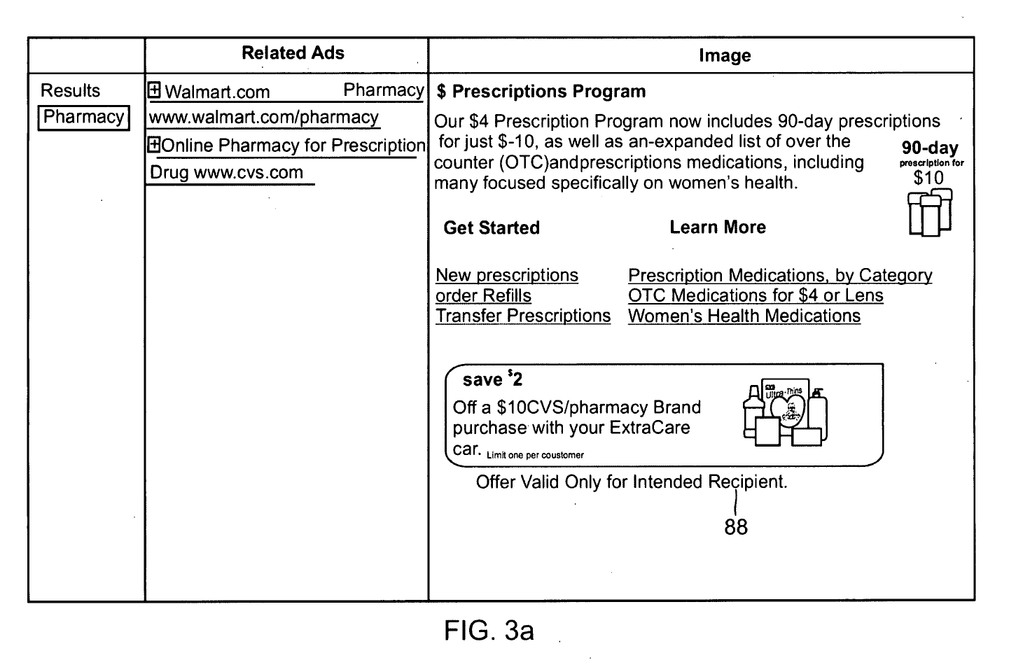

FIG. 3 represents a flow diagram as would be found in an embodiment of the invention. The CPE 58 monitors all traffic from LAN or Wireless LAN. The computer 74 sends a request 16 through the CPE 58. The request passes through Enet1 42 LAN and the Ehternet Switch 76 to the CPU 56.

From the CPU 56 the request 16 is directed to a memory 78. The inspection engine 80 then performs an analysis to determine if user preference information is part of the request 16. The CPE 58 filters non-HTTP information due to information (content) on the World Wide Web (WWW), which is formatted using the Hypertext Markup Language (HTML). For example, the CPE 58 collects the followings by inspecting outbound packets: access URL/address, zip code location, Traffic protocol, Source MAC address of traffic request, Source IP address of traffic, Source WAN IP address, Destination IP address, Key words, Timing Sessions etc.

If user preference information is identified, then the user preference information 20 is sent to the memory database 82 and ultimately the ad server 86. The targeted ad information 32 is sent from the ad server 86 and the memory database 82 to the computer 74. To reduce redundancy, the CPU 56 or the ad server 86 can monitor the advertising data to prevent the ad server 86 and the memory database 82 from sending the same advertisements to the computer 74.

In other embodiments, the CPE 58 might not include a memory database 82. In that case, the ad server 86 controls the advertisements sent to the computer 74. Meanwhile, the response to the search request 94 is transmitted to the CPE 58 and ultimately the computer 74.

The CPE compares the information with a local database, memory database 82, that is stored on the memory to see whether any matching Ads. If these ads are related to a specific topic from memory or local data base, it will deliver to the CPE and user.

In another embodiment, if there is no matching ad from local database, then the user specific information is sent to the backend server for recording and further analyses. The ad server 86 or backend server can update the advertising information in the memory database 82. This allows the CPE 58 to retain more information locally and reduces the time needed for response from the ad server 86.

The ad server 86 returns the information requested to the computer 74 through the CPE 58. The relevant ads 68 are also sent to the computer 74. In this embodiment, the relevant ads 68 are either from the CPE 58 or the ad server 86. In other embodiments, the relevant ads 68 can be a combination of recommended ads from the CPE 58 and the ad server 86.

The external website 84 receives the request 16 and sends a response to the search request 94 to the CPE 58, which is directed to the computer 74. The user then receives a response to the request and tailored advertisement information.

One of the benefits to this method is to provide more accurate information to site's visitors while doing the internet surfing. This can be referred to as a “Precise Ad” or tailored advertisement. For example, it will allow delivering real-time inline ads when users do the research or latter provision the relevant information to users after goes through the user's behavior analysis on the back end server.

The ads will be delivered to the specific PC like pop-up or floating and the specific area or site on the CPE where can display. For example, the software makes a request by sending an XML POST command to the following URL: http://deviceweb/ . . . /set_client_ads.xml.
1. specific PC like pop-up, pop-under or floating
2. specific email address
3. specific mobile device
4. and the specific area or site on the CPE where can display such as Web GUI. For example, the software makes a request by sending an XML POST command to the following URL:http://deviceweb/ . . . /set client ads.xml. An example is shown in FIG. 3a. The image in this figure is for a coupon 88.

The Web GUI (Graphic User Interface) in one embodiment is a browser implemented in HTML and running in the CPE to enable the access and manage the CPE over a network using a Web browser. For example, users can turn on and off this ads function as well as the area of interest such as keywords or preferred URLs.

As a non-limiting example, below is a sample layout and codes in xml.

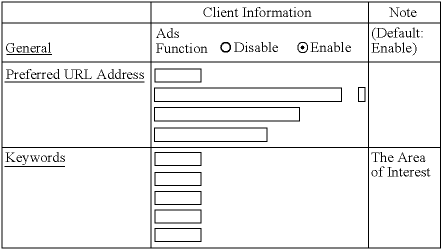

```
− <ClientInformation>
  <version>@xml_ver#</version>
  − <AdsFunction>
  − <General>
    <enable>@h_ads_function_xml#</enable>
      </General>
      − <PreferredURL>
        <PreferredURLList>@request_url_list#</PreferredURLList>
        </PreferredURL>
  − <Keywords>
  <KeywordList>@access_keyword_list#</KeywordList>
  </Keywords>
  </General>
</AdsFunction>
</ClientInformation>
```

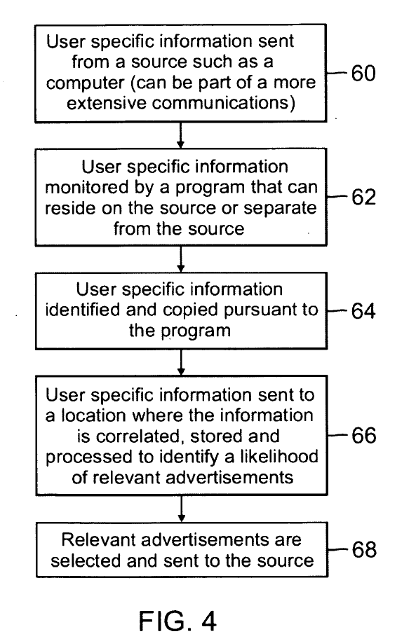

Turning to FIG. 4, the process for one embodiment of the invention is described. To begin, a source such as a computer sends user specific information 60 to a destination such as a specific URL on the internet or other destination on a closed network to name just two options. The information can include user preference information such as, for example, the URL address of the source and the intended destination. At some point in the process monitoring 62 occurs, which can be accomplished in a number of ways. For example, a software program may rely upon a list of keywords. The information is monitored to identify any of the listed keywords. If a keyword is found, then specific information identified 64 is copied in a memory. For example, URL may be a keyword and a URL address may be identified and copied. This information is sent 66 to a location external to the source, such as an external server, for analysis. In other embodiments, the analysis could be performed at the source or on other user premise equipment. In yet another embodiment, the analysis and associated tasks could be divided between an external source and the user premise equipment. The analysis determines what advertisements might be relevant to the user based at least partially upon the user specific information. Once relevant advertisements are identified, relevant ads 68 are sent to the source.

One embodiment of the invention allows users to use CPE as their home address to receive regular MAILS (used to be sent by the marketing company and received in the front door mailbox). This can also include such items as weekly Best-Buy newspaper printed inserts Supermarket's grocery coupons.

Companies (e.g., Best-Buy™, Wall-Mart™, Target™, CVS Pharmacy™, Department Store, Supermarket, etc.) utilizing this method of opened marketing channel can promote their business. For example, it would distribute the promotion ad to the specific ZIP.

The user's preference information is sent to the backend server and collected. That is, it is stored with other user information, unless it is the first such information received. In that instance it is the first to be collected information. The collected information is ultimately used to identify advertisements that may be of relevance to the user. It is not necessary to rely upon all of the collected information although all the collected information could be used in some cases. The collected information provides a database of historical data by the user.

Evaluating the collected information can be directed to the reliance on all the collected information or less that the entire amount of the collected information. For example, more recent collected information may be given higher weight in an analysis than older information. At some point the older information may be entirely irrelevant to any analysis and possibly discarded.

Further by way of example, some information may be more relevant to interests and hobbies, news, or sports chat, while other information more pertinent to commercial items for purchase. Naturally, if the recent query is directed to purchases then information on news may not be relevant to the analysis and thus not utilized.

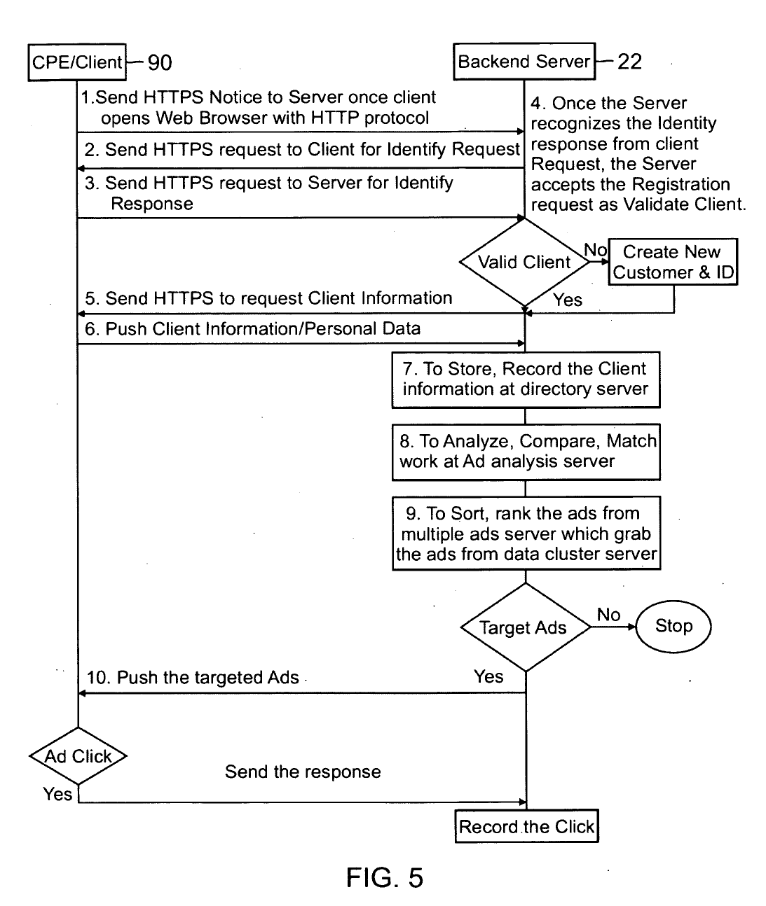

FIG. 5 is a flowchart addressing one embodiment of the invention. In this embodiment, the client 90 initiates a session on the internet by opening a web browser. In response the backend server 22 communicates with the client 90 to identify the request. The client 90 notifies the backend server 22 of the identify response.

The backend server 22 then validates the client. IF this is a new client then a new customer and client identification are created by the backend server 22. Client information is then requested by the backend server 22. The client information which can include personal data is pushed to the backend server 22. The information is then stored on the directory server. The analysis server then analyzes the data.

This analysis can include identifying the keywords to determine if there is a product being sought. It can also include direct requests to the system to request information for a specific item.

The information in this embodiment is sorted and ranked. Then advertisements that may be of interest to a client 90 are identified from a data cluster server. If no target ads can be identified, then the process stops. In such a case, the process repeats with new client requests.

If target advertisements are identified, then the information is pushed to the client 90. If the client 90 clicks on an advertisement with a mouse for example, then the click is recorded by the backend server 22.

While this embodiment utilizes the internet, the invention is broader and not limited to only internet applications.

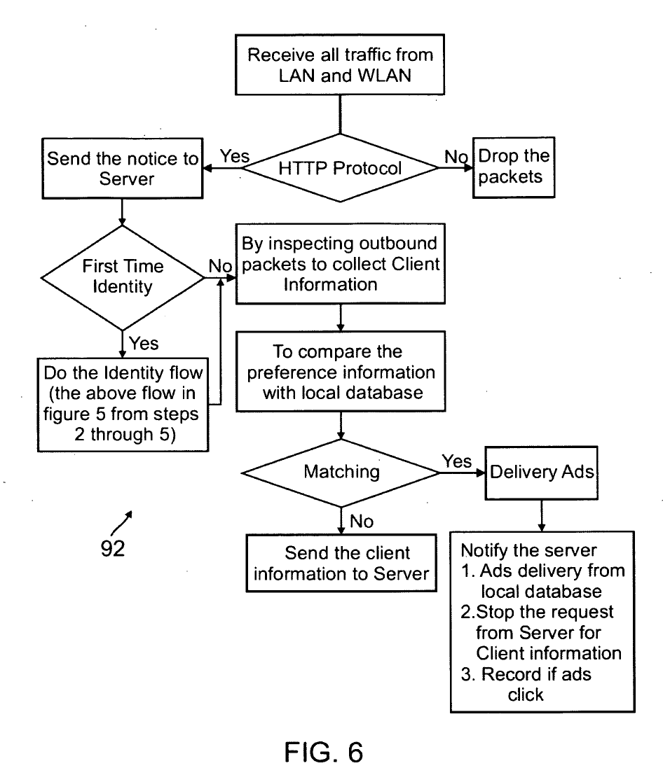

Turning to FIG. 6, an embodiment is identified that addresses HTTP protocols. The implementation can be on a local router or other client hardware capable of executing such a process. This is generally referred to as a system device 92. However, the implementation of the method may be on external equipment or distributed between the system device 92 and other equipment that can be local or external to the client.

To begin, the system device 92 received the LAN and/or WLAN traffic from a client. A determination is made to identify if the traffic is based upon HTTP protocols. If the information is not HTTP, then the packets are dropped. If the packets are HTTP protocol based, then notice is sent to the server.

The server determines if the client is being identified for the first time. If so, then the process outlined in FIG. 5 in steps 2 through 5 are performed. The outbound packets are inspected to obtain client preference information.

The preference information is compared to a local database. This can be a database stored in the system device such as a local router or other local equipment. If matches are not identified based upon the client preference information, then this information is sent to a server. If matches are identified in local equipment such as a router, the advertisements are delivered from the local database to the client. In such a case, the option exists to not receive information from an external server.

If the advertisements are chosen by the client then the choice is recorded. Choosing can be accomplished by using a mouse to click on the advertisement.

The advertisements could be presented to a user through software loaded on a user's computer to allow for placement of the advertisements. The software could be designed for use with the backend servers or local equipment hosting the program. For example, the software may place the advertisements on the left of the viewable screen. In a different embodiment, the software may allow the user to open a separate screen that presents the targeted advertisements.

While the present invention has been described with respect to particular physical embodiments, the invention is not limited to the particulars described above; instead, the scope of the invention is defined by the following claims.

What is claimed is:

1. A method for tailoring advertisement content to a specific user within a network, the method comprising the steps of:
inspecting information sent from a user's premises equipment over the network;
identifying user preference information being included in the information sent over the network;
transmitting user preference information over the network to a location external to the user's premises equipment;
collecting user preference information at the location external to the user's premises equipment;
evaluating the collected user preference information to identify potential areas of interest of the user;
selecting advertisements based upon the identification of the potential areas of interest of the user; and
transmitting selected advertisements over the network to the user's premises equipment for communicating said information to the user.

2. The method for tailoring advertisement content to a specific user within a network of claim 1 wherein the user's premises equipment is a router.

3. The method for tailoring advertisement content to a specific user within a network of claim 1 wherein the router inspects the information.

4. The method for tailoring advertisement content to a specific user within a network of claim 2 wherein the network is the internet.

5. The method for tailoring advertisement content to a specific user within a network of claim 4 wherein the location external to the user's premises equipment is a server.

6. The method for tailoring advertisement content to a specific user within a network of claim 5 wherein the user may modify user preference information at the location external to the user's premises equipment.

7. A method for tailoring advertisement content to a specific user on the internet, the method comprising the steps of:
utilizing software that resides on a user's premises equipment to inspect information sent from said equipment over the internet;
identifying user preference information using said software based upon information sent from said equipment over the internet;
transmitting user preference information over the network to a backend server on the internet;
collecting user preference information at the backend server;
evaluating the user preference information at the backend server to identify potential areas of interest of the user;
selecting advertisements based upon the identification of the potential areas of interest of the user; and
transmitting selected advertisements over the internet to the user's premises equipment.

8. A method for tailoring advertisement content to a specific user using a communications device within a network, the method comprising the steps of:
utilizing software that resides on a user's premises equipment to inspect information sent from the communications device over the network;
identifying user preference information using said software based upon information sent from said equipment over the network;
transmitting user preference information over the network to a location external to the user's premises equipment;
collecting user preference information;
evaluating the user preference information to identify potential areas of interest of the user;
selecting advertisements based upon the identification of the potential areas of interest of the user; and
transmitting selected advertisements over the network to the user's premises equipment and from there to a device that displays the advertisements to the user.

9. The method for tailoring advertisement content to a specific user using a communications device within a network of claim 8 wherein the device that displays the advertisements to the user is a computer.

10. The method for tailoring advertisement content to a specific user using a communications device within a network of claim 8 wherein the device that displays the advertisements to the user is a cell phone.

11. A method for providing advertisements to a user, the method comprising the steps of:
receiving a communication that includes user preference information;
searching for user preference keywords in the received communication;
identifying the user preference information in the received communication;
correlating the identified user preference information to a database of advertisements; and
transmitting to the user at least one advertisement based upon the correlated user preference information.

12. The method for providing advertisements to a user of claim 11, wherein the database of advertisements is based upon a compilation of earlier acquired user preference information.

13. A method for providing advertisements to a user, the method comprising the steps of:
means for receiving information that includes user preference information;
means for identifying the user preference information in the received information;
means for identifying advertisements based upon the user preference information; and
means for transmitting to the user at least one advertisement.

14. A method for tailoring advertisement content to a specific user within a network, the method comprising the steps of:
utilizing a user's premises equipment to inspect information sent from said equipment over the network to identify user preference information being included in the information sent over the network;
identifying at least one tailored advertisement as part of an analysis performed by the user premises equipment, and;
notifying the user of the at least one tailored advertisement.

15. A method for evaluating user preference information to tailor advertisement content to a specific user within a network, the method comprising the steps of:
receiving current user preference information;
determining if prior advertisements were sent to the user based on prior related user preference information;
selecting which prior advertisements should be chosen for transmission to the user;
searching a database of advertisements for current advertisements related to the current user preference information;
selecting which of the current advertisements should be chosen for transmission to the user;
merging selected prior advertisements with current advertisements related to the current user preference information; and
transmitting the merged advertisements to the user.

16. A method for tailoring advertisement content to a specific user within a network, the method comprising the steps of:
inspecting information sent from a user's premises equipment over the network wherein the inspection occurs within a router;
identifying user preference information being included in the information sent over the network within said router;
collecting user preference information at the router;
evaluating the collected user preference information within the router to identify potential areas of interest of the user;
selecting advertisements stored within the router based upon the identification of the potential areas of interest of the user; and
transmitting selected advertisements to the user's premises equipment for communicating said information to the user.
